(19) United States
(12) Patent Application Publication
(10) Pub. No.: US 2015/0198251 A1
(43) Pub. Date: Jul. 16, 2015

(54) BRUSH SEAL HAVING BRUSH FILAMENTS OF NONMETALLIC MATERIALS

(71) Applicant: MTU Aero Engines AG, Munich (DE)

(72) Inventors: Stefan Beichl, Herrsching (DE); Alfons Gail, Friedberg (DE)

(21) Appl. No.: 14/593,093

(22) Filed: Jan. 9, 2015

(30) Foreign Application Priority Data
Jan. 14, 2014 (DE) 10 2014 200 525.6

(51) Int. Cl. F16J 15/32

(52) U.S. Cl. CPC F16J 15/3288; F16J 15/328

(57) ABSTRACT

Brush seal and method for the production thereof, the brush seal being composed of filament bundles that lie tightly adjacent to one another and are wound in bundles around a core element (14), the free filament ends (filament region 16) being arranged at a lay angle (α) deviating from 90° relative to the core element (14), and are held permanently by means of clamping members (18, 21, 23) that partially enclose the latter.

### BACKGROUND OF THE INVENTION

The invention relates to a method for producing brush seals having brush filaments made of nonmetallic materials as well as brush seals according to this method.

Employed for special cases of grinding applications as contact seals between parts that move relative to one another are so-called brush seals, the sealing faces of which are formed by the front and/or side faces of filament bundles that are arranged in tightly spaced rows and generally held by a metal frame.

It has been demonstrated to be advantageous in this case when the brush filaments, which are parallel to one another and project from the metal frame, are arranged at an oblique angle to the latter and not orthogonal to it, that is, they exhibit a so-called lay angle.

When brush filaments made of metal are used, this lay angle is permanently fixed by annealing after laying the brush filaments. Such a method is time-consuming and costly, because special apparatuses are needed for annealing in a vacuum oven.

Required for many application purposes, however, are non-metallic brush filaments for which fixing of a desired lay angle cannot be performed by annealing.

### SUMMARY OF THE INVENTION

The object of the invention is to create a remedy here by way of a new inexpensive method for producing brush seals that have a straight or bent extension with brush filaments made of nonmetallic materials, as well as brush seals produced by this method.

This object is achieved by the method as well as by the brush seals in accordance with the present invention.

Further features are also provided by the present invention.

The measures according to the invention enable a requisite lay angle also to be created and permanently fixed for brush seals having nonmetallic brush filaments and, in addition, to do so in a simpler and more cost-effective manner than hitherto has been the case. In this case, it is possible to use nonmetallic materials both for the brush filaments and for the core element and clamping member. However, it is also possible to fabricate the clamping member from metallic materials, the only decisive factor being to permanently produce a sufficiently large clamping force for the brush filaments. The cross section of the clamping members can be selected at will and can thus have circular or rectangular configurations. The brush seals can also be straight or bent or else circular in form.

### BRIEF DESCRIPTION OF THE DRAWING FIGURES

The invention is described below on the basis of a number of exemplary embodiments illustrated more or less schematically in the drawing:

Shown are:

FIG. 1 a cutout of a plan view, in partial sectional illustration, of a brush seal with straight extension according to a first exemplary embodiment of the invention,

FIG. 2 a section according to line II-II in FIG. 2,

FIG. 3 a cutout of a plan view, in partial sectional illustration, of a second embodiment of a brush seal with straight extension according to the invention,

FIG. 4 a section according to line IV-IV in FIG. 3,

FIG. 5 a cutout of a plan view, in partial sectional illustration, of a brush seal with bent extension according to a third exemplary embodiment of the invention, and

FIG. 6 a plan view of a ring-shaped embodiment of a brush seal according to the invention.

### DESCRIPTION OF THE INVENTION

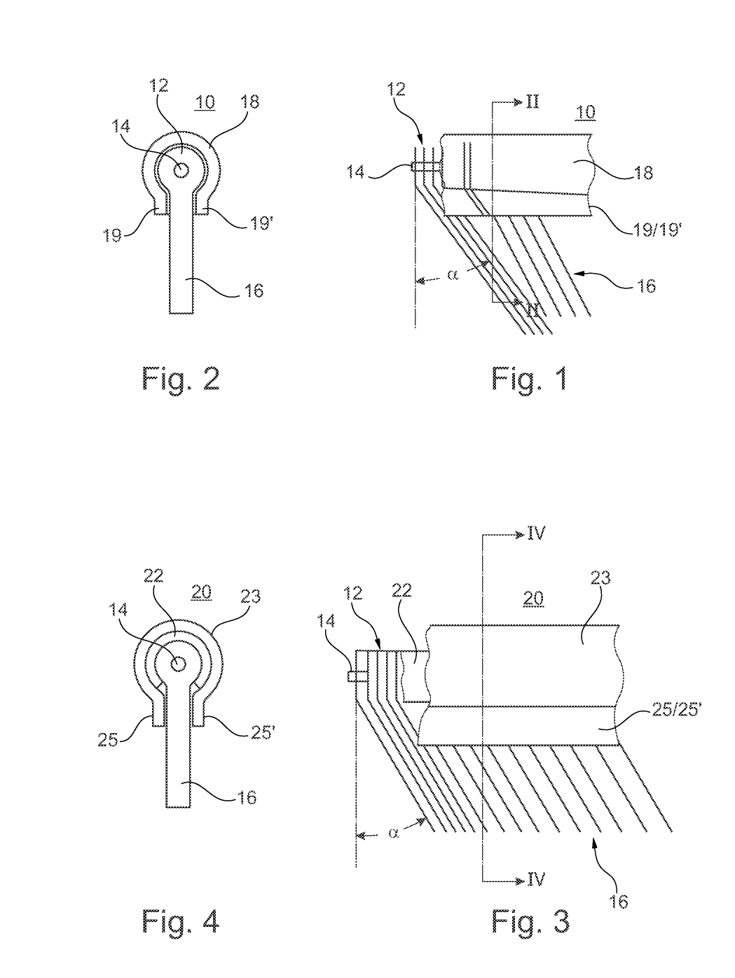

A brush seal with a straight extension, illustrated only partially in FIG. 1 and referred to overall with the reference number 10, comprises bundled brush filaments 12, which lie tightly spaced with respect to one another and are made of nonmetallic material, preferably KEVLAR 49, and which, in turn, are tightly wound around a core element 14 with a likewise straight extension and a roughly circular cross section, and the free ends 16 of the filaments lying substantially parallel to one another extend away from the core element 14; see FIG. 2. In this case, the free ends 16 of the brush filaments, as illustrated in FIG. 1, are bent at a lay angle α of about 45° with respect to the core element 14, this bending being performed after the winding of the core element. The brush filaments are held permanently in this bent position by means of a clamping member 18 that is put in place after bending is complete.

In this case, the clamping member 18 surrounds the part of the brush filament bundle that is wound around the core element 14 and, with its end regions, forms so-called crimped edges 19, 19′, the areas of which lie tightly against the brush filaments at the transition from the winding into the free end region and, as a result, permanently fix in a form-fitting manner the free ends 16 of the brush filaments, which are bent by the lay angle α, in the illustrated bent position.

Partially illustrated in FIGS. 3 and 4 is another exemplary embodiment of a brush seal, identified overall by the reference number 20. In this case, identical components corresponding to the first exemplary embodiment have the same reference numbers. The sole difference is the type of clamping, which, in this case, occurs by means of two clamping members 22 and 23. The interposition of the first clamping member 22 enables a larger circumference, that is, a larger diameter, to be achieved for the second clamping member 23, which, in turn, leads to greater clamping forces on the crimped edges 25, 25′, which correspond to the crimped edges 19, 19′ corresponding to the clamping member 18 and the areas of which likewise lie tightly against the brush filaments at the transition from the winding into the free end region.

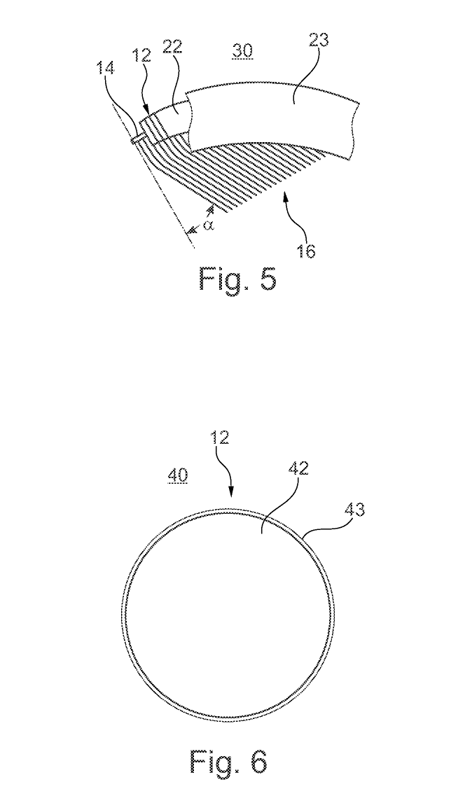

Illustrated in FIG. 5 is a third exemplary embodiment of a brush seal 30 in a bent construction, the components of which correspond substantially to the already described components and therefore bear the same reference numbers.

Shown in FIG. 6 is a ring-shaped brush seal 40 with a relatively small diameter. Here, too, identical components are identified by the same reference numbers, with the provision that an annular core element 42 and an annular clamping ring 43 are provided. The clamping ring 43 is clamped in place after bringing the free ends 16 of the brush filaments 12 into the angled position enclosing the lay angle α.

Bringing the brush filaments 12 into the angled position takes place in such a way that, after winding with the associated filament bundles 12, the core element 42 is placed on a mandrel of corresponding diameter, the filament ends 16 are bent by rotation of the mandrel, and, subsequently, the clamping ring 43 is put in place, which permanently fixes the filaments bent at the lay angle α.

The core elements 14 and 42 are preferably also fabricated from nonmetallic materials, whereas metallic materials, such as, for example, brass, can also be used for the clamping members 18, 22, 23, and 43.

What is claimed is:

1. A method for producing a brush seal that has a straight or bent extension, comprising the steps of:
providing a brush seal having brush filaments made of nonmetallic materials, the brush filaments being laid tightly adjacent to one another in bundles around a core element, the filaments lying substantially parallel to one another, and the free filament ends of the brush filaments, which adjoin the winding of the core element and amount to more than 180°;
bringing the brush filaments into a lay angle deviating from 90° with respect to the core element, and
permanently fixing the brush elements in place.

2. The method according to claim 1, wherein the step of permanently fixing the brush elements in place is carried out by mechanical clamping.

3. The method according to claim 1, further comprising the step, prior to producing the desired lay angle, an annular core element bearing filament bundles, tightly arranged adjacently in rows, is placed on a mandrel of about the same diameter, the free ends are brought into the desired lay angle by rotation of the mandrel, and then are permanently fixed in their angled position by subsequent application of a corresponding clamping ring.

4. A brush seal, comprising:
brush filaments (12) are arranged on a core element (14) so as to lie tightly adjacent to one another in bundles;
free ends (16) of the brush filaments, lying in a position substantially parallel to one another and exhibiting a lay angle (α) that deviates from 90° with respect to the core element (14); and
the free filaments being held permanently in the position, via a clamping member (18), which partially encloses the core element (14) and the brush filaments (12) surrounding it.

5. The brush seal according to claim 4, further comprising an additional clamping member (18) associated with the clamping member (18), the free crimped edges (19, 19′) of which lie tightly against the brush filaments (12).

6. The brush seal according to claim 4, wherein the clamping member (18, 23) has crimped edges (19, 19′, 25, 25′), the areas of which are held permanently in their position against the free ends (filament region 16) of the brush filaments (12) that are bent by the lay angle (α).

7. The brush seal according to claim 4, wherein the clamping member (18) transitions into the regions that are adjacent to the winding around the core element (14) and that are parallel to the free end regions lying at the filament bundles at crimped edges (19, 19′, 25, 25′).

8. The brush seal according to claim 4, wherein the core element (14) has a straight or bent form.

9. The brush seal according to claim 4, wherein the core element is a circular ring (42) and a clamping ring (43) surrounding the core element is used as the clamping member.

10. The brush seal according to claim 4, wherein the lay angle (α) of the free ends (16) of the brush filaments (12) is 45°.
